(19) United States
(12) Patent Application Publication
(10) Pub. No.: US 2025/0102642 A1
(43) Pub. Date: Mar. 27, 2025

(54) DTOF RANGING METHOD AND SYSTEM

(71) Applicant: SHENZHEN ADAPS PHOTONICS TECHNOLOGY CO., LTD., Shenzhen (CN)

(72) Inventors: Letian WANG, Shenzhen (CN); Chao ZHANG, Shenzhen (CN)

(21) Appl. No.: 18/898,159

(22) Filed: Sep. 26, 2024

(30) Foreign Application Priority Data
Sep. 26, 2023 (CN) 202311256347.8

(51) Int. Cl. G01S 7/4863; G01S 7/484; G01S 7/4865

(52) U.S. Cl. CPC G01S 7/4863; G01S 7/484; G01S 7/4865

(57) ABSTRACT

The invention discloses a dTOF ranging method and a dTOF ranging system, which are applied to the field of optical measurement technology. The method includes setting a first mode and a second mode; wherein the first mode activates the corresponding SPADs according to the first area position information, and outputs the data of each pixel through the TDC array according to the number of components in the first pixel; the second mode activates the corresponding SPADs according to the second area position information, and outputs the data of each pixel through the TDC array according to the number of components in the second pixel. The position information of each area includes the block size of the corresponding area of the SPAD array and the position of the SPAD. The method also includes switching between the first mode and the second mode according to user-input command.

### CROSS-REFERENCES TO RELATED APPLICATIONS

This application is a continuation of and claims priority to Chinese Patent Application No. CN202311256347.8, filed on Sep. 26, 2023, which is incorporated herein in its entirety.

### FIELD

The present invention relates generally to the field of optical measurement technology.

### BACKGROUND

ToF (Time of flight) includes dToF (direct Time-of-Flight) and iToF (indirect Time-of-Flight). Such ranging systems are typically used with RGB lenses, such as in focusing, AR (Augmented Reality), and obstacle avoidance application scenarios.

In the related technology, the ToF ranging system lens may be fixed-focus. If the RGB lens is a zoom lens, when the focal length of the RGB lens is increased, the angular resolution of the ToF ranging system lens remains unchanged, and the effective resolution left under the corresponding visual angle may be insufficient, resulting in reduced depth pixel resolution and inadequate depth information, which affect the accuracy of the target identification. For example, in an interchangeable lens camera equipped with a ToF-assisted focusing element, adjusting the focus ring while enlarging the field of view does not enhance angular resolution. In mobile phone photography, switching ToF focus from main to telephoto lenses results in insufficient angular resolution due to the fixed pixel size of the ToF sensor within relatively enlarged fields of view. Attempts to overcome resolution deficiencies by increasing pixel count in ToF devices necessitate enlarging the photosensitive area, thereby escalating chip and optical system costs and reducing spatial efficiency, rendering such solutions impractical.

### SUMMARY

Embodiments of the present invention that are described hereinbelow provide a dTOF ranging method and a dTOF ranging system, which can change the angular resolution with low cost and high efficiency.

An aspect of the present application provides A dTOF (direct Time-of-Flight) ranging method, comprising: setting a first mode and a second mode, wherein in the first mode, selected SPADs (Single Photon Avalanche Diodes) are activated based on first area position information, and pixel data is output through a TDC (Time-to-Digital Converter) array according to a number of SPADs in each pixel, and wherein in the second mode, the selected SPADs are activated based on second area position information, and pixel data is output through the TDC array according to the number of SPADs in each pixel; switching between the first mode and the second mode based on a user-input; generating a histogram from the TDC data of each pixel to determine the depth value of each pixel; wherein the first area position information includes a block size of a first area of an SPAD array and positions of the SPADs within the first area; the second area position information includes a block size of a second area of the SPAD array and positions of the SPADs within that area; the first area is larger than the second area, and the number of SPADs per pixel in the first area is greater than the number of SPADs per pixel in the second area.

In a disclosed embodiment, the first area and the second area include the same or different SPADs.

In another embodiment, the number of components in the first pixel is the number of SPADs contained in each pixel in the first mode; the number of components in the second pixel is the number of SPADs contained in each pixel in the second mode; The first number of pixels being different from the second number of pixels.

In another embodiment, the block area of the first area is greater than the block area of the second area, and the number of components in the first pixel is greater than the number of components in the second pixel.

In an alternative embodiment, before the user-input, the method further includes obtaining the user-input through the I2C interface of the dTOF device.

In an alternative embodiment, the block area of the first area is twice of the block area of the second area.

In an alternative embodiment, wherein the step of switching the first mode and the second mode according to user-input command, further includes setting a third mode; switching the first mode, the second mode and the third mode according to user-input command; wherein the third mode activates the corresponding SPADs according to the third area position information; outputting the data of each pixel through the TDC array according to the number of components in the third pixel; the third area information comprises a block size of the third area of the SPAD array and SPAD positions; The second area is larger than the third area, and the number of components in the second pixel is larger than the number of components in the third pixel.

There is also provided, in accordance with an embodiment of the invention, A dTOF (direct Time-of-Flight) ranging system, comprising: an SPAD array (Single Photon Avalanche Diode array); a TDC array (Time-to-Digital Converter array); a register for storing configuration information, including the number of SPADs per pixel; an I2C interface; and a controller; Wherein the I2C interface is connected to the register and the controller; the controller is connected to the SPAD array and the TDC array; the controller is configured to execute the steps of the dTOF ranging method as described in any one of preceding embodiments, by running a computer program stored in a memory.

In an alternative embodiment, the invention further includes an area array emitting end and an optical signal driver; the optical signal driver is connected with the area array emitting end; the area array emitting end is used for outputting the area array optical signal; It includes a vertical cavity surface emitting laser and a diffusion element; the vertical cavity surface emitting laser includes at least two laser signal output channels; the diffusion element is used for diffusing the optical signals output by the vertical cavity surface emitting laser to achieve uniform distribution of the laser; the optical signal driver adjusts the power consumption frame by frame through the I2C interface to match with the frame by frame adjustment of the angular resolution.

In addition to the aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements.

FIG. 1 is a flow chart of a dTOF ranging method according to the present invention.

FIG. 2 is a flow chart of a dTOF ranging method in an alternative embodiment provided.

FIG. 3 is a schematic diagram of a mode configuration in an alternative embodiment.

FIG. 4 is a schematic diagram of mode switching in an alternative embodiment.

FIG. 5 is a schematic diagram of an original image in an alternative embodiment.

FIG. 6 is an enlarged schematic view of the local area of FIG. 5.

FIG. 7 is a schematic diagram of a SPAD read by a large area array in an alternative embodiment.

FIG. 8 is a schematic diagram of a SPAD read by a small area array in an alternative embodiment.

FIG. 9 is a schematic diagram of the SPAD of the scattered reading in an alternative embodiment.

FIG. 10 is a structural diagram of a specific embodiment of the dTOF ranging device.

FIG. 11 is a structural diagram of an embodiment of the electronic device.

FIG. 12 is a structural diagram of one embodiment of the dTOF ranging device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

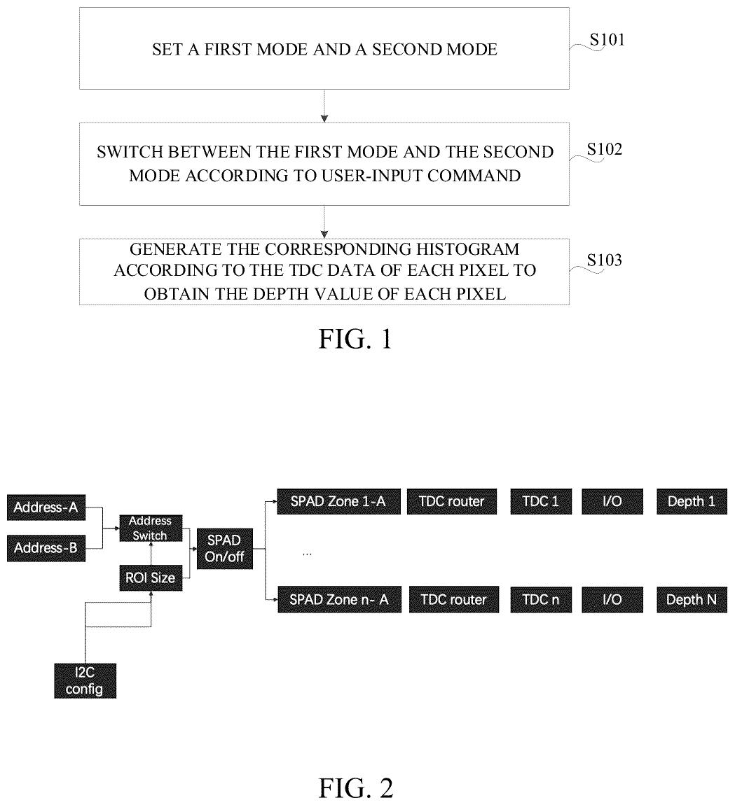

These and other embodiments are described with reference to FIGS. 1-12. However, those skilled in the art will readily appreciate that the detailed description given herein with respect to these figures is for explanatory purposes only and should not be construed as limiting.

The terms “first”, “second” etc., used in the specification, claims and the aforementioned drawings are intended to distinguish different objects, rather than to describe a particular order. In addition, the terms “including” and “having” and any variations thereof are intended to include non-exclusive inclusion. For example, a process, method, system, product or device incorporating a series of steps or units is not limited to listed steps or units, but may include unlisted steps or units. Various non-limiting embodiments of the present application will be described in detail below.

Referring first to FIG. 1, FIG. 1 is a flow chart of a dTOF ranging method provided by the present application, and the present application may include the following contents. S101: Set a first mode and a second mode.

In this embodiment, the first mode activates corresponding SPADs according to first area position information, the first area position information includes block size of the first area of the SPAD array and SPAD positions, which outputs data of each pixel through the TDC array according to the number of components in the first pixel. The second mode activates corresponding SPADs according to the second area position information, and outputs the data of each pixel through the TDC array according to the number of components in the second pixel, and the second area information comprises the block size of the second area of the SPAD array and the SPAD positions. Related data of the first mode and the second mode can be stored in the SRAM (Static Random-Access Memory), and switched according to the required mode carried in the user-input command. The block size of the first area and the block size of the second area equal to the size of ROI (region of interest), i.e. the number of pixels for binning, the block size of the first area and the SPAD positions, the block size of the second area and the SPAD positions are determined according to the size of the ROI (region of interest), i.e. the number of pixels for binning. The SPAD position in the first area position information refers to the position where the SPADs to be activated in the first mode, and the SPAD position in the second area position information refers to the position where the SPADs to be activated in the second mode. The first area and the second area may include the same or different or partially overlapping SPADs, which does not affect the implementation of the present application, and those skilled in the art may make flexible adjustments according to actual requirements. The number of components in the first pixel is the number of SPADs contained in each pixel in the first mode; the number of components in the second pixel is the number of SPADs contained in each pixel in the second mode; The number of components in the first pixel may be one pixel including one SPAD, and the number of components in the second pixel may be one pixel including 2*2 SPAD. Since the first mode and the second mode correspond to different angular resolutions, the number of components in the first pixel being different from the number of components in the second pixel. In order to facilitate description and embody different resolutions corresponding to different modes, the embodiment defines that the area of the first area is greater than the area of the second area, and the number of components in the the first pixel is greater than that of the second pixel.

S102: Switch between the first mode and the second mode according to user-input command.

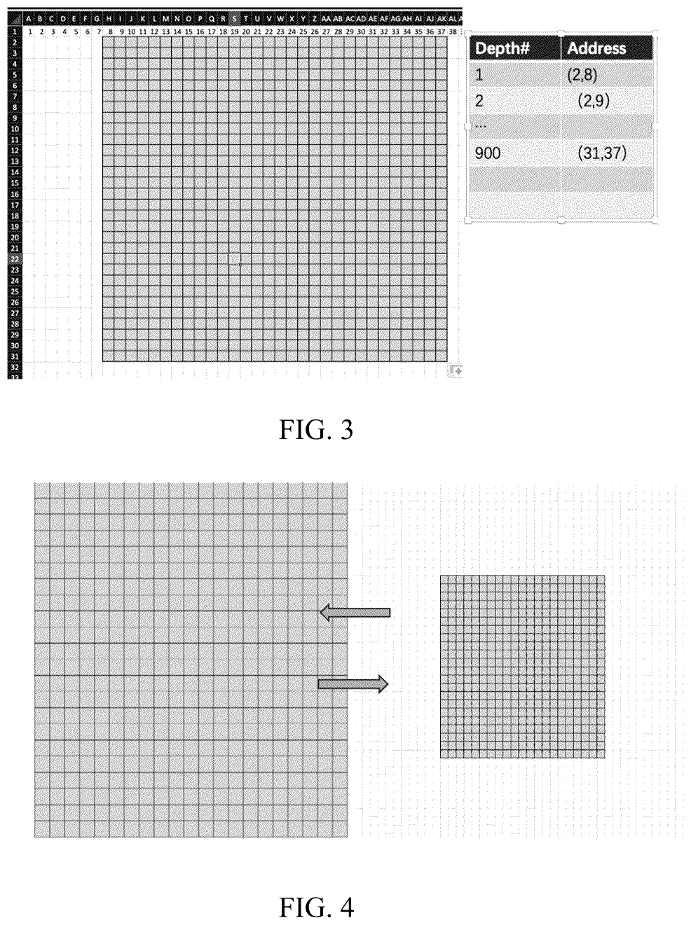

When S101 is configured with the first mode and the second mode, in the actual application process, as shown in FIG. 2, Address A and Address B are repectively the first area position information and the second area position information, the user performs mode switching according to the needed angular resolution, when the system receives the user-input command, the SPAD of the optical signal output in the current mode is closed, and starting the corresponding SPAD based on the block size and SPAD position of the SPAD array area of the corresponding mode. As shown in FIG. 3, the size of ROI is 1*1, that is, the opening area of ROI is 1*1 SPAD binning, each grid represents one SPAD, and the right side is the position information of each SPAD. The corresponding SPAD can be activated based on the size and address information of the ROI of 1*1. In order to achieve the opening of any of the foregoing locations in the manner in which different SPAD regions are linked to the nearby TDC, embodiments may define a TDC (time digital converter) router (TDC router). The TDC router (TDC router) can pre-store signal transmission path optimization information, and the optical signal transmission path optimization information can determine the TDC receiving the optical signal of the SPAD at the corresponding position of the first area and the second area. In this way, the optical signal of each SPAD in the on state can be input to the corresponding TDC through the TDC router according to the corresponding binning, and then the depths of the corresponding positions are output 1, 2, . . . N.

S103: Generate the corresponding histogram according to the TDC data of each pixel to obtain the depth value of each pixel.

After the optical signal of the SPAD in the corresponding mode in the SPAD array is input to the corresponding TDC in the last step, according to the TDC detection record, after N times of emission and reception, the TDC can record n times of optical flight time, so as to generate a histogram about the flight time distribution, according to the maximum flying time value of the appearing frequency in the histogram, it is the target value, namely the depth value.

In the technical solution provided by the application, the photosensitive pixel number and the photosensitive pixel position can be adjusted by setting different modes, the user can select the mode matched with the needed angular resolution by issuing the instruction according to the actual requirement, the effective change of the angular resolution can be realized by switching the instruction, The whole realizing process does not need to increase the photosensitive area, which can realize changing the angular resolution with low cost and high efficiency.

Further, in order to realize the switching with different resolutions frame by frame, the size of the ROI can be configured through the I2C (Inter-Integrated Circuit) interface of the dTOF device. The switching of different modes can also be implemented through the IC interface, that is, the instruction input by the user can be obtained through the I2C interface of the dTOF device, and the dTOF device refers to any hardware device used in the method of the embodiment or internally provided with the method. By using the I2C configuration mode, the whole angular resolution can be improved and the switching speed can be switched frame by frame.

The above embodiments do not limit the parameter configuration in different modes and the switching in different modes, and based on this, the present application also provides various embodiments, which may include the following contents.

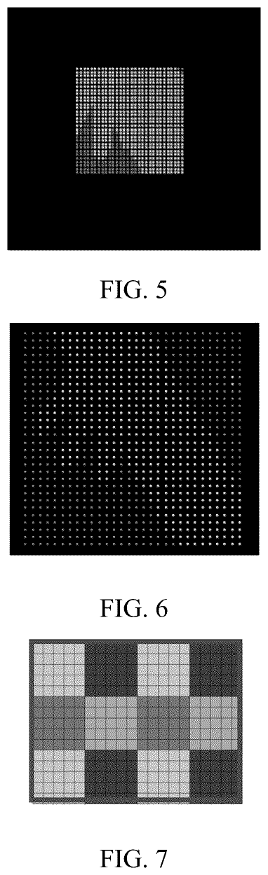

As an alternative embodiment, if the block area of the first area is greater than the block area of the second area, the number of components in the first pixels is greater than the number of components in the second pixel. As shown in FIG. 4, each grid represents the size of one pixel, the left figure represents 2*2, and the right figure represents 1*1, 2×2 binning and 1×1 binning can be switched. If one pixel in the first mode comprises 2*2 SPAD, and the first area comprises 30*30 pixels, then the angular resolving power is equal to 60°/30 pixel=2°/pixel. if one pixel in the second mode comprises 1*1 spad, the number of SPAD included in the pixel is reduced, the same SPAD array can comprise more pixels, the second area comprises 30*30 pixels, The angular resolving power is equal to 30°/30 pixel=1°/pixel. The first mode is switched to the second mode, i.e., from 2×2 binning to 1×1 binning, and the angular resolving power is reduced, so that increase the angular resolution, the angular resolving power and the angular resolution are reciprocal to each other. Correspondingly, when the magnification of RGB is switched to 2.5 times, the depth of the dTOF is changed from the first mode to the second mode, and the area to be amplified can contain more pixels in the second mode, which is beneficial for improving the precision of the depth information. Compared with the prior art, the number of pixels is not changed, one pixel comprises 2*2 SPAD, when the magnification of RGB is switched from 1 to 2.5 times (i.e., the viewing angle is from large to small), such as amplifying FIG. 5 to FIG. 6, dTOF does not change the number of pixels. it is still 2*2 SPAD, then the position of the amplified area after switching can only comprise 15*15 pixels, the angular resolving power is equal to 60°/15 pixel=4°/pixel, the angular resolving power is larger, resulting in smaller angular resolution, That is, the area to be amplified can only include 15*15 pixels, the depth value is too small, and the depth data of the target hand in FIG. 6 is not enough, which cannot satisfy the application, that is, the RGB image is amplified, and the depth value also needs to be changed when the detail map needs to be viewed, Otherwise, a magnified target hand only has several depth data, and cannot see more depth data.

Considering that the angular resolving power required by different application scenes is different, it is realized by configuring different SPAD positions and different binning. An exemplary block area of the first area is larger than a block area of the second area, and the number of pixels opened in the first area is equal to the number of pixels opened in the second area. In an alternative embodiment, the block area of the first area can be set to be 2 times of the block area of the second area, when the original image is 1 times, the whole SPAD is activated, when the image is amplified by 2 times, only half of the SPAD is activated fixedly, so the angular resolution can be ensured to be increased, and the calculation is relatively good.

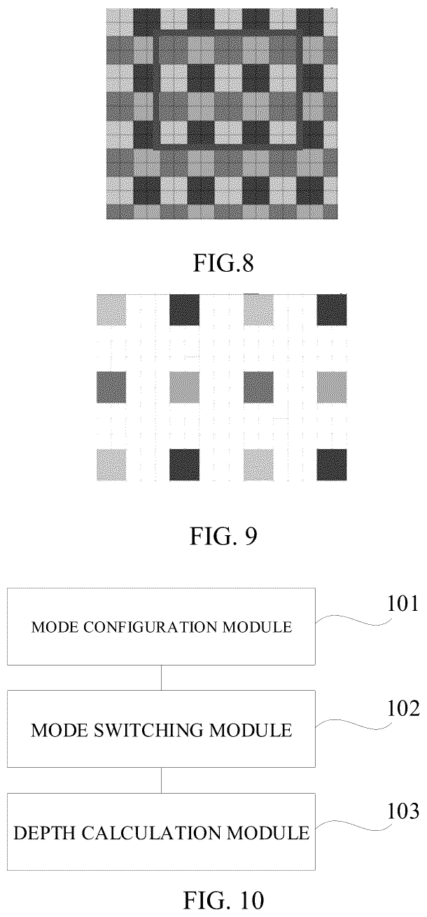

According to the size of the total number of SPAD, a plurality of types of conversion can be achieved, taking FIG. 7 as an example, the grayscale color in different 4 in the FIG. 7 represents the time-sharing read data, if it is partially amplified, then switching from one pixel comprising 5*5 SPAD to one pixel comprising 2*2 SPAD shown in FIG. 8, at the same time, switching the large view angle fov to the small fov, according to the position information and block size of the SPAD of the first mode and the second mode, starting the SPAD of the second area, The SPAD of the first area is turned off. If the SPAD is an area array, that is, the number of SPAD is large, and is switched from FIG. 8 to FIG. 9, the number of pixels opened before and after the switching is increased, the number of pixels opened in the first area+the second area before the switching is 4*3, and the number of pixels opened in the second region after the switching is 5*4. if it is the scatter point switching to the area array, that is, switching from one pixel comprising 2*2 SPAD to one pixel comprising 5*5 SPAD, that is, switching from FIG. 10 to FIG. 8, the distance of the area array is the size of one pixel, the distance of the scatter point is greater than the size of one pixel, the position is not changed, The number of binning is increased, correspondingly, the precision of the depth value is increased. That is, if the angular resolution corresponding to the second mode is higher than the angular resolution corresponding to the first mode, 1) when the user-input command is an angular resolution amplification request, setting the SPAD in the second area of the SPAD to be in an activated state according to the first area position information and the second area position information, The SPAD in the first area of the SPAD is in a closed state, the pixel is switched from including m*n SPAD to including 1 SPAD, and the viewing angle is also increased from small to large during the switching process. 2) when the user-input command is an angular resolution reducing request, according to the first area position information and the second area position information, setting the SPAD in the first area of the SPAD to be in an activated state, The SPAD in the second area of the SPAD is in a closed state, and the pixel is switched from including 1 SPAD to including m*n SPAD, and the viewing angle is also reduced from large to small during the switching process.

It can be seen from the above, the embodiment provides switching situations of various angular resolutions, which can realize improvement of different angular resolutions, and has better flexibility; and when the angular resolution is improved, under the small fov, there can be more pixels so as to improve the precision of the depth information.

Further, in order to improve the practicability, based on the above embodiments, it is also possible to configure a plurality of modes according to the actual situation to implement the corresponding switching of different resolutions, and the present embodiment may include the following contents: setting a third mode, and switching the first mode, the second mode and the third mode based on the instruction input by the user.

In this embodiment, the third mode activates the corresponding SPAD according to the third area position information; according to the number of components in the third pixel, outputting the data of each pixel through the TDC array; the third area information comprises the block size of the third area of the SPAD array and SPAD positions; The area of the first area is greater than the area of the second area, the area of the second area is greater than the area of the third area, the number of components in the first pixel is greater than the number of components in the second pixel, and the number of components in the second pixel is greater than the number of components in the third pixel.

It should be noted that there is no strict sequence of execution among the steps in the present application, so long as the logical sequence is satisfied, the steps can be executed at the same time, and also can be executed according to a certain set sequence, FIG. 1 is only a schematic manner, and does not mean that the execution sequence can only be executed.

The application also provides a corresponding device for the dTOF ranging method, further making the method more practical. The device can be respectively explained from the angle of the functional module and the angle of the hardware. The dTOF ranging device provided by the present application will be described below, and the device is used to implement the ranging method provided by the present application. The ranging method disclosed in the first embodiment has been completed by one or more processors. The program module referred to in this application refers to a series of computer program instruction segments capable of completing specific functions, which are more suitable for describing the execution process of the ranging device in the storage medium than the program itself. The following description will specifically describe the functions of the program modules of the present embodiment, and the dTOF ranging apparatus described below and the dTOF ranging method described above can be referred to each other correspondingly.

Based on the angle of the functional module, referring to FIG. 10, FIG. 10 is a structural diagram of the dTOF ranging device provided by the present application in one embodiment, and the device may include: a mode configuration module 101, configured to set a first mode and a second mode; wherein the first mode activates the corresponding SPAD according to the first area position information, and outputs the data of each pixel through the TDC array according to the number of the first pixels; the second mode activates the corresponding SPAD according to the position information of the second area, and outputs the data of each pixel through the TDC array according to the number of components in the second pixel; wherein the first area position information comprises the block size of the first area of the SPAD array and SPAD positions; the second area information comprises the block size of the second area of the SPAD array and SPAD positions; the first area is larger than the second area, and the number of components in the first pixel is larger than the number of components in the second pixel; a mode switching module 102, configured to perform mode switching on the first mode and the second mode according to user-input command; the depth calculation module 103 generates a corresponding histogram according to the TDC data of each pixel to obtain a depth value of each pixel.

In an alternative embodiment, the first area and the second area include the same or different SPAD.

In an alternative embodiment, the number of components in the first pixel is the number of SPADs included in each pixel in the first mode; the number of components in the second pixel is the number of SPADs contained in each pixel in the second mode; The first number of pixels being different from the second number of pixels.

In an alternative embodiment, the block area of the first area is greater than the block area of the second area, and the number of components in the first pixel is greater than the number of components in the second pixel.

As an alternative embodiment, the above mode switching module 102 is further configured to: user-input is obtained through the I2C interface of the dTOF device.

In an alternative embodiment, the block area of the first area is larger than a block area of the second area, and the number of pixels opened in the first region is equal to the number of pixels opened in the second region.

In an alternative embodiment, the block area of the first area is 2 times the block area of the second area.

As another alternative embodiment, the above mode switching module 102 may be further configured to switch the first mode, the second mode and the third mode according to user-input command; wherein the third mode is set, and the third mode activates the corresponding SPAD according to the third area position information; according to the number of components in the third pixel, outputting the data of each pixel through the TDC array; the third area information comprises the block size of the third area of the SPAD array and SPAD positions; The second area is larger than the third area, and the number of components in the second pixel is larger than the number of components in the third pixel.

The functions of each functional module of the dTOF ranging device of the present application can be specifically implemented according to the method in the above embodiments of the method, and the specific implementation process can be described with reference to the above embodiments of the method, and will not be described here.

From the above, it can be seen that the present embodiment can change the angular resolution with low cost and high efficiency . . . .

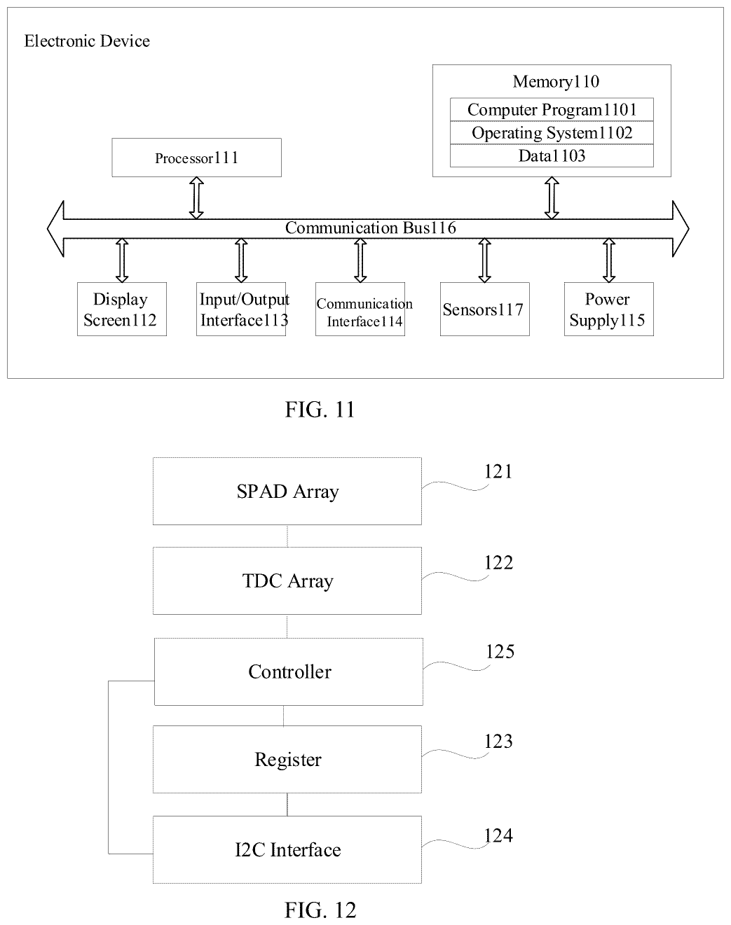

The dTOF ranging device mentioned above is described from the perspective of the functional module, and further, the present application also provides an electronic device, which is described from the perspective of hardware. FIG. 11 is a structural diagram of an electronic device according to an embodiment of the present application. As shown in FIG. 11, the electronic device includes a memory 110 for storing a computer program; The processor 111 is configured to implement the steps of the dTOF ranging method as mentioned in any of the above embodiments when executing a computer program.

The processor 111 may include one or more processing cores, such as a four-core processor and an eight-core processor. The processor 111 may also be a controller, a microcontroller, a microprocessor or other data processing chips. The processor 111 may use DSP (Digital Signal Processing), FPGA (Field-Programmable Gate Array), PLA (Programmable Logic Array), at least one hardware form is implemented. The processor 111 may also include a main processor and a coprocessor, the main processor being a processor for processing the data in the awake state, also called a Central Processing Unit (CPU); The coprocessor is a low power consumption processor for processing data in a standby state. In some embodiments, the processor 111 may be integrated with a GPU (Graphics Processing Unit) for rendering of the content to be displayed on the display screen. In some embodiments, the processor 111 may also include an AI (Artificial Intelligence) processor for processing computing operations related to machine learning.

The memory 110 may include one or more computer-readable storage media, which may be non-temporary. The memory 110 may also include a high speed random access memory and a non-volatile memory, such as one or more disk storage devices, flash memory storage devices. The memory 110 may, in some embodiments, be an internal storage unit of an electronic device, such as a hard disk of a server. The memory 110 may, in other embodiments, also be an external storage device of an electronic device, such as a plug-in hard disk, a Smart Media Card (SMC), a Secure Digital (SD) card, Flash Card and so on. Further, the memory 110 may include both the internal storage unit of the electronic device and the external storage device. The memory 110 may not only be used to store application software and various types of data installed in the electronic device, for example: The code or the like of the program during the execution of the dTOF ranging method may also be used to temporarily store data that has been output or is to be output. In this embodiment, the memory 110 is at least used for storing the following computer program 1101, wherein the computer program is loaded and executed by the processor 111, and then the related steps of the dTOF ranging method disclosed in any one of the above embodiments can be implemented. In addition, the resources stored in the memory 110 may also include an operating system 1102 and data 1103 and the like, and may be stored temporarily or permanently. The operating system 1102 may include Windows, Unix, Linux and so on. The data 1103 may include, but are not limited to, data corresponding to the ranging result.

In some embodiments, the electronic device described above may also include a display screen 112, an input-output interface 113, a communication interface 114, or a network interface, a power supply 115, and a communication bus 116. Wherein, the display screen 112 and the input/output interface 113, such as the Keyboard, belong to the user interface, and the optional user interface may also include a standard wired interface, a wireless interface, and so on. Optionally, in some embodiments, the display may be an LED display, a liquid crystal display, a touch liquid crystal display, an OLED (Organic Light-Emitting Diode) touch device, or the like. The display may also suitably be referred to as a display screen or a display unit for displaying information processed in the electronic device and for displaying a visual user interface. The communication interface 114 may optionally include a wired interface and/or a wireless interface, such as a WI-FI interface, a Bluetooth interface, or the like, typically used to establish a communication connection between an electronic device and other electronic devices. The communication bus 116 may be a peripheral component interconnect standard. (PCI) bus or extended industrial standard structure (EISA) bus and so on. The bus can be divided into address bus, data bus, control bus and so on. In order to facilitate the presentation, only one thick line is used in FIG. 11, but not only one bus or one type of bus.

It will be understood by those skilled in the art that the structure shown in FIG. 11 is not intended to constitute a limitation on the electronic device, and may include more or less components than those shown in the drawings, for example, may also include sensors 117 for implementing various functions.

The functions of each functional module of the electronic device according to the present application can be specifically implemented according to the method in the above embodiments of the method, and the specific implementation process can be described with reference to the above embodiments of the method, and will not be described herein.

From the above, it can be seen that the present embodiment can change the angular resolution with low cost and high efficiency.

It will be understood that if the dTOF ranging method in the above embodiments is implemented in the form of software functional units and sold or used as a separate product, it may be stored in a computer readable storage medium. Based on such an understanding, the technical solution of the present application can be embodied in the form of a software product, which is stored in a storage medium, in essence or in part or all of the technical solution or in part contributing to the related technology, All or part of the steps of the method of each embodiment of the present application are performed. The aforementioned storage medium includes: a U disk, a mobile hard disk, a Read-Only Memory (ROM), a Random Access Memory (RAM), an electrically erasable programmable ROM, a register, a hard disk, a multimedia card, Various media that can store program codes, such as a card-type memory (e.g., SD or DX memory, etc.), magnetic memory, removable disk, CD-ROM, disk, or optical disk.

Based on this, the present application also provides a readable storage medium in which a computer program is stored, the computer program being executed by a processor the steps of the dTOF ranging method as described in any of the above embodiments.

Finally, the present application also provides a dTOF ranging system, see FIG. 12, which may include an SPAD array 121, a TDC array 122, a register 123, an I2C interface 124 and a controller 125.

The I2C interface 124 is connected to the register 123 and the controller 125, respectively, and the controller 125 is connected to the SPAD array 121 and the TDC array 122, respectively, the register 123 is configured to store configuration information including the number of SPAD components included in a single pixel; The controller 124 is used to implement the steps of the dTOF ranging method as described in any of the embodiments above when executing the computer program stored in the memory.

It can be understood that the dTOF ranging system further comprises an area array emitting end (such as VCSEL, LED infrared light emitting device), an optical signal driver, the SPAD array image sensor. The optical signal driver is connected with the area array emitting end; the SPAD array image sensor is connected with the TDC array. The VCSEL driver and the SPAD array image sensor can be combined together. In order to realize that the energy can be adjusted frame by frame, the area array emitting end adopts the area array illumination, that is, the area array emitting end of the embodiment is used for outputting the area array optical signal, which can comprise a vertical cavity surface emitting laser and a diffusion element; The diffusing element is used for diffusing the optical signal output by the vertical cavity surface emitting laser so that the laser is uniformly distributed. the vertical cavity surface emitting laser comprises at least two laser signal output channels; A channel can be used for the middle region and another channel can be used for the edge, which is matched with the switching of the angular resolution so as to realize the illumination with higher efficiency; Further, while increasing the angular resolution (i.e., reducing the angular resolving power), the number of SPAD contained by each depth pixel is reduced. When it is detected that the light intensity of the outdoor environment is large, the laser intensity at the emitting end of the area array needs to be increased to maintain enough signal-to-noise ratio, that is, enough detection distance.

Further, since it may be necessary to expand the power consumption to see a long distance after expanding the resolution, in order to cooperate with the function of subsequent frame-by-frame adjustment of angular resolution, the optical signal driver can perform frame-by-frame adjustment of power consumption through the I2C interface, to support multi-channel output of EN (enable) signal, to match with the frame-by-frame adjustment of the angular resolution.

A using scene based on the dTOF ranging system recorded by the embodiment is a ToF auxiliary focusing tool aiming at an interchangeable lens camera, with the user continuously rotating the focusing ring, amplifying to a certain degree, it needs to expand the resolution of the ToF focusing tool, which can set a certain threshold value, amplifying to a certain angle, and then starting. the other using scene is aiming at the mobile phone, the mobile phone is switched from the main to the telephoto in the shooting process, because the mobile phone has such a switching button for the portrait or long-distance object, so the interaction judgment is simple; In addition, after the telephoto is used, there will naturally be an amplification step, and then the viewing angle in the red frame will just fill the viewing angle of the camera.

The function of each functional module of the dTOF ranging system according to the embodiment of the present invention can be specifically implemented according to the method in the embodiment of the above method, and the specific implementation process can be described with reference to the related description of the embodiment of the above method, and will not be described here.

From the above, it can be seen that the present embodiment can change the angular resolution with low cost and high efficiency.

The various embodiments in the present specification are described in a progressive manner, and each embodiment is focused on the differences from other embodiments, and the same or similar parts of the various embodiments are referred to each other. For the hardware including devices and electronic devices disclosed in the embodiments, since it corresponds to the method disclosed in the embodiments, the description is relatively simple, and reference is made to the method part for description.

It will be further appreciated by those skilled in the art that various exemplary units and algorithm steps described in connection with the embodiments disclosed herein can be implemented in electronic hardware. In order to clearly illustrate the interchangeability of hardware and software, various exemplary compositions and steps have been generally described in the above description in accordance with the functions. Whether these functions are performed in hardware or software depends on the particular application and design constraints of the technical solution. Those skilled in the art can use different methods for each particular application to implement the described functions, but such implementation should not be considered to be outside the scope of this application.

The dTOF ranging method and the dTOF ranging system provided by the present application are described in detail above. The principles and embodiments of the present application are illustrated by specific examples applied herein, and the description of the above embodiments is only used to assist in understanding the method of the present application and the core idea thereof. It should be noted that, for those skilled in the art, the present application can be improved and modified without departing from the principle of the present application, and these improvements and modifications are also within the protection scope of the Claims of the present application.

What is claimed is:

1. A dTOF (direct Time-of-Flight) ranging method, comprising:
setting a first mode and a second mode, wherein in the first mode, selected SPADs (Single Photon Avalanche Diodes) are activated based on first area position information, and pixel data is output through a TDC (Time-to-Digital Converter) array according to a number of SPADs in each pixel, and wherein in the second mode, the selected SPADs are activated based on second area position information, and pixel data is output through the TDC array according to the number of SPADs in each pixel;
switching between the first mode and the second mode based on a user-input;
generating a histogram from the TDC data of each pixel to determine the depth value of each pixel;
wherein: the first area position information includes a block size of a first area of an SPAD array and positions of the SPADs within the first area;
the second area position information includes a block size of a second area of the SPAD array and positions of the SPADs within that area;
the first area is larger than the second area, and the number of SPADs per pixel in the first area is greater than the number of SPADs per pixel in the second area.

2. The method of claim 1 wherein the first area and the second area comprise the same or different SPADs.

3. The method of claim 1, wherein the number of components in the first pixel is the number of SPADs contained in each pixel in the first mode; the number of components in the second pixel is the number of SPADs contained in each pixel in the second mode; the first number of pixels being different from the second number of pixels.

4. The method of claim 1, before the user-input, further comprising: obtaining the user-input through the I2C interface of the dTOF device.

5. The method of claim 1, wherein the block area of the first area is greater than the block area of the second area; the number of the pixels correspondingly opened in the first area equals the number of the pixels correspondingly opened in the second area.

6. The method of claim 1, wherein the block area of the first area is twice of the block area of the second area.

7. The method of claim 1, wherein the step of switching the first mode and the second mode according to user-input command, further comprising:
setting a third mode;
switching the first mode, the second mode and the third mode according to user-input command;
wherein the third mode activates the corresponding SPADs according to the third area position information; outputting the data of each pixel through the TDC array according to the number of components in the third pixel; the third area information comprises the block size of the third area of the SPAD array and SPAD positions; the second area is larger than the third area, and the number of components in the second pixel is larger than the number of components in the third pixel.

8. A dTOF (direct Time-of-Flight) ranging system, comprising:
an SPAD array (Single Photon Avalanche Diode array);
a TDC array (Time-to-Digital Converter array);
a register for storing configuration information, including the number of SPADs per pixel;
an I2C interface;
and a controller;
wherein: the I2C interface is connected to the register and the controller;
the controller is connected to the SPAD array and the TDC array;
the controller is configured to execute the steps of the dTOF ranging method as described in any one of claim 1, by running a computer program stored in a memory.

9. The system of claim 8, further comprising an area array emitting end and an optical signal driver; the optical signal driver is connected with the area array emitting end;
the area array emitting end is used for outputting the area array optical signal; it comprises a vertical cavity surface emitting laser and a diffusion element; the vertical cavity surface emitting laser comprises at least two laser signal output channels; the diffusion element is used for diffusing the optical signals output by the vertical cavity surface emitting laser to achieve uniform distribution of the laser;
the optical signal driver adjusts the power consumption frame by frame through the I2C interface to match with the frame by frame adjustment of the angular resolution.
